(19) United States
(12) Patent Application Publication
(10) Pub. No.: US 2024/0387854 A1
(43) Pub. Date: Nov. 21, 2024

(54) APPARATUS FOR A HIGH ENERGY DENSITY PRISMATIC BATTERY CELL WITH BUILT-IN FOAM

(71) Applicant: GM GLOBAL TECHNOLOGY OPERATIONS LLC, Detroit, MI (US)

(72) Inventors: Sherman H. Zeng, Troy, MI (US); Liang Xi, Northville, MI (US); Binsong Li, Troy, MI (US); SriLakshmi Katar, Troy, MI (US)

(73) Assignee: GM GLOBAL TECHNOLOGY OPERATIONS LLC, Detroit, MI (US)

(21) Appl. No.: 18/320,569

(22) Filed: May 19, 2023

(51) Int. Cl. H01M 10/04; H01M 10/052; H01M 10/658

(52) U.S. Cl. CPC H01M 10/0431; H01M 10/0468; H01M 10/052; H01M 10/658

(57) ABSTRACT

A prismatic battery cell is provided. The prismatic battery cell includes a hard outer case including an internal volume and an electrode stack or a jelly roll electrode disposed within the internal volume. The prismatic battery cell further includes a foam structure disposed within the internal volume. The foam structure is configured for applying a desirable pressure upon the electrode stack or the jelly roll electrode and for compressing when the electrode stack or the jelly roll electrode expands.

### INTRODUCTION

The disclosure generally relates to an apparatus for a high energy density prismatic battery cell with built-in foam.

A battery includes at least one pair of an anode electrode and a cathode electrode and a separator disposed between the anode electrode and the cathode electrode. Each of the anode electrode and the cathode electrode includes or is formed upon a current collector which may be a conductive metal piece utilized to conduct electrical energy from the respective electrode to a battery terminal. The anode electrode is connected to a negative battery terminal, and the cathode electrode is connected to a positive battery terminal. A battery may include a can or an outer rigid housing useful to contain and protect the electrodes and separator. The can may be constructed of a metal.

An electrode stack may include one or more electrode pairs. According to one embodiment, the electrode stack may include a plurality of alternating flat electrodes. According to another embodiment, the electrode stack described as a jelly roll electrode stack may include a single flexible pair of electrodes, with the electrodes rolled into a cylindrical or a flattened cylindrical shape. A jelly roll electrode stack includes an outer separator layer and an inner separator layer, a cathode layer, an inert laminate layer, and an anode layer. Viewing an end of the jelly roll electrode stack, the layers may appear as a swirl, with the anode layer and the cathode layer separated by the separator layer. The anode layer may be connected to a negative battery terminal through a first current collector, and the cathode layer may be connected to a positive battery terminal through a second current collector.

### SUMMARY

A prismatic battery cell is provided. The prismatic battery cell includes a hard outer case including an internal volume and one or more electrode stacks or jelly roll electrodes disposed within the internal volume. The prismatic battery cell further includes a foam structure disposed within the internal volume. The foam structure is configured for reducing the cell internal pressure upon the electrode stack or the jelly roll electrodes through foam compression when the electrode stack or the jelly roll electrode expands.

In some embodiments, the electrode stack or jelly roll electrode includes a silicon anode or a lithium metal anode.

In some embodiments, when the electrode stack of the jelly roll electrode expands, the foam structure is configured for exhibiting strain in a range from 0% to 80% at a pressure of less than 600 kilopascals.

In some embodiments, the prismatic battery cell further includes a liquid electrolyte. The foam structure is configured for absorbing the liquid electrolyte in a range from 0% of a volume of the foam structure to 4% of the volume of the foam structure.

In some embodiments, the foam structure includes a first foam layer abutting a first side of the electrode stack or the jelly roll electrode and disposed between the first side of the electrode stack or the jelly roll electrode and an inner surface of the hard outer case. The foam structure further includes a second foam layer abutting a second side of the electrode stack or the jelly roll electrode and disposed between the second side of the electrode stack or the jelly roll electrode and the inner surface of the hard outer case.

In some embodiments, the prismatic battery cell includes the jelly roll electrode, and the battery cell includes a plurality of jelly roll electrodes. The foam structure includes a foam layer disposed between a first of the plurality of jelly roll electrodes and a second of the plurality of jelly roll electrodes.

In some embodiments, the foam layer is a first foam layer. The prismatic battery cell further includes a second foam layer abutting a first side of a first of the plurality of jelly roll electrodes and disposed between the first side and an inner surface of the hard outer case. The prismatic battery cell further includes a third foam layer abutting a second side of a second of the plurality of jelly roll electrodes and disposed between the second side and the inner surface of the hard outer case.

In some embodiments, the prismatic battery cell further includes a foam wrap surrounding the plurality of jelly roll electrodes.

In some embodiments, the prismatic battery cell includes the electrode stack. The foam structure includes a first foam layer abutting a first side of the electrode stack and disposed between the first side of the electrode stack and an inner surface of the hard outer case. The foam structure further includes a second foam layer abutting a second side of the electrode stack and disposed between the second side of the electrode stack and the inner surface of the hard outer case.

In some embodiments, the battery cell includes the electrode stack, and the foam structure is a foam wrap surrounding the electrode stack.

In some embodiments, the foam structure is constructed with a silicone

rubber.

In some embodiments, the foam structure is constructed with a polyurethane material.

In some embodiments, the foam structure is constructed of a composite material or multilayer material including a silicone rubber or a polyurethane material.

In some embodiments, the prismatic battery cell further includes a first tab and a second tab. The foam structure includes open ends enabling various positions for the first tab upon the battery cell and for the second tab upon the battery cell.

In some embodiments, the prismatic battery cell further includes a liquid electrolyte. The foam structure includes a different surface polarity from a polarity of the liquid electrolyte.

In some embodiments, the prismatic battery cell further includes a built-in spring applying a compressive force upon a first side of the electrode stack or jelly roll electrode. The foam structure includes a foam layer in contact with a second side of the electrode stack or jelly roll electrode.

In some embodiments, the prismatic battery cell further includes a built-in spring applying a compressive force upon a first side of the electrode stack or jelly roll electrode. The foam structure includes a first foam layer in contact with a second side of the electrode stack or jelly roll electrode. The prismatic battery cell further includes a second foam layer disposed between the built-in spring and the first side of the electrode stack or jelly roll electrode.

According to one alternative embodiment, a battery module is provided. The battery module includes a plurality of battery cells. Each of the plurality of battery cells includes a hard outer case including an internal volume and one or more electrode stacks or jelly roll electrodes disposed within the internal volume. Each of the plurality of battery cells further includes a foam structure disposed within the internal volume configured for reducing the cell internal pressure upon the electrode stack or the jelly roll electrodes through foam compression when the electrode stack or the jelly roll electrode expands.

According to one alternative embodiment, a system including a device including a battery module is provided. The system includes the device. The device includes the battery module including a plurality of battery cells. Each of the plurality of battery cells includes a hard outer case including an internal volume and an electrode stack or a jelly roll electrode disposed within the internal volume. Each of the plurality of battery cells further includes a foam structure disposed within the internal volume configured for reducing the cell internal pressure upon the electrode stack or the jelly roll electrodes through foam compression when the electrode stack or the jelly roll electrode expands.

In some embodiments, the device is a vehicle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in side cross-sectional view an exemplary prismatic battery cell including a hard outer case, electrode stacks, and at least one built-in foam structure, embodied by foam layers, pressing upon the electrode stacks, in accordance with the present disclosure;

FIG. 2 schematically illustrates in cross-sectional view a battery module including a plurality of battery cells, in accordance with the present disclosure;

FIG. 3 schematically illustrates in cross-sectional view a battery cell including a jelly roll electrode and foam layers, in accordance with the present disclosure;

FIG. 4 schematically illustrates in perspective view the foam layer of FIG. 3, in accordance with the present disclosure;

FIG. 5 schematically illustrates in cross-sectional view a battery cell including a jelly roll electrode and a foam wrap, in accordance with the present disclosure;

FIG. 6 schematically illustrates in perspective view the foam wrap of FIG. 5, in accordance with the present disclosure;

FIG. 7 schematically illustrates in cross-sectional view a battery cell including a plurality of jelly roll electrodes disposed between a plurality of foam layers, in accordance with the present disclosure;

FIG. 8 schematically illustrates in cross-sectional view a battery cell including a plurality of jelly roll electrodes, a plurality of foam layers disposed between the jelly roll electrodes, and a foam wrap disposed surrounding the jelly roll electrodes and between the jelly roll electrodes and a hard outer case of the battery cell, in accordance with the present disclosure;

FIG. 9 schematically illustrates in cross-sectional view a battery cell including a plurality of electrode stacks and a foam wrap disposed surrounding the electrode stacks, in accordance with the present disclosure;

FIG. 10 schematically illustrates an exemplary device including the battery module and utilizing electrical energy stored there within, in accordance with the present disclosure;

FIG. 11 schematically illustrates in cross-sectional view an exemplary battery cell including a plurality of electrode stacks, a first foam layer, a second foam layer, and a spring configured to apply compressive force upon the electrode stacks and the foam layers, in accordance with the present disclosure; and

FIG. 12 schematically illustrates in cross-sectional view an exemplary battery cell including a plurality of electrode stacks, a foam layer, and a spring configured to apply compressive force upon the electrode stacks and the foam layer, in accordance with the present disclosure.

### DETAILED DESCRIPTION

Some battery cells may include anode electrodes that may be described as high-expansion anode electrodes. A lithiation and delithiation process may be described as occurring on an anode electrode during cyclical charging and discharging cycles, respectively. As a result of the lithiation and delithiation process in the battery cell, the anode electrode volume may change from a maximum volume to a minimum volume. The anode electrode volume change from the minimum volume to the maximum volume may be described as an anode electrode expansion ratio. In one embodiment, a high-expansion anode electrode may be described as having an anode electrode expansion ratio of at least 1.5 to 1.

In another embodiment, an anode electrode within an electrode stack of a prismatic battery cell may cause unacceptable expansion of the electrode stack when a hard case deformation limit is exceeded. In one example, an anode-less lithium anode during lithiation may create or cause a total thickness of the electrode stack exceeding a hard case deformation limit due to large electrode expansion. Such large electrode expansion may occur either at the end of lithiation due to reversible volume expansion or at the end of cell cycle life due to the combination of reversible and irreversible volume expansion.

Pressure within a prismatic battery cell affects battery cell performance and lifespan. If an electrode is subject to too much pressure, an electrode film may crack and cause the increased cell resistance or lithium dendrite growth. Additionally, high pressure during cell charging may cause a hard outer case of the prismatic battery cell to become deformed or damaged. If an electrode is subject to too low pressure, a contact between electrode layers or contact between particles in an electrode film may be poor, which may increase cell resistance and decrease the cell performance. High pressure within the battery cell primarily originates from anode electrode expansion. Both the anode and the cathode have a maximum pressure limit regarding mechanical stability and cell performance. A minimum desired electrode pressure and a maximum desired electrode pressure or a desired electrode pressure range may be defined for an anode electrode and a cathode electrode.

If a high-expansion anode electrode is disposed within a prismatic battery cell with a rigid outer housing, during the large changes in volume that occur during cyclical charging and discharging cycles, both anode and cathode electrodes are likely to experience either high pressure conditions when the volume of the anode electrode increases and the electrode presses outwardly against the rigid outer housing or low pressure conditions when the volume of the anode electrode decreases and the pressure within the battery cell drops.

An apparatus including a prismatic battery cell including internal or built-in foam to enable use of high-expansion anode electrodes is provided. Proposed prismatic cells with built-in foam as pressure control enable the usage of high-expansion anodes towards high energy density prismatic cells without the issue of large cell and module expansion. The disclosed prismatic battery cells with built-in foam as pressure control enable the usage of high-expansion anodes in order to achieve high energy density prismatic battery cells. The built-in foam within the prismatic battery cell enables the anode electrode to expand and shrink within the hard outer case of the prismatic battery cell while staying within a desired electrode pressure range. The built-in foam provides a buffer, maintaining at least a minimum desired electrode pressure within the prismatic battery cell during delithiation and maintaining an electrode pressure below a maximum desired electrode pressure during lithiation.

The disclosed prismatic cell design utilizes foam layers or foam wraps inside the battery cell case to mitigate the overpressure issue that results from high-expansion anodes, such as lithium metal and high-silicon content anodes. The foam with specific material and structure can also mitigate a thermal runaway risk. The battery cell design enables the usage of the anode materials with high capacity and high expansion rate towards a goal of prismatic cells with excellent energy density. The foam absorbs the large expansion of the electrode stack during cell charging and constantly provides stack pressure during cell discharging to maintain a proper in-cell pressure range. The smaller cell expansion resulted in lower maximum cell face pressure in the battery module, which enabled thinner end plates and side plates and reduced the pack cost and mass. Similar foam layers or wraps may be used on prismatic can cells with jelly roll electrode configurations and with electrode stacks with different active materials.

A plurality of wound jelly roll electrodes within a battery module or a plurality of stacked electrodes within a battery module may be separated from each other with foam pads or wraps. The prismatic can cells may have various tab locations and/or electrode stacking directions without affecting the usefulness of the disclosed foam.

In a battery cell with three or more wound jelly roll electrodes inside the single battery cell, if the plurality of jelly roll electrodes are affixed or anchored to one side of the battery cell case, the jelly roll electrodes on the opposite side of the battery cell case may include a maximum moving distance that may cause excess wear upon the battery cell case. The disclosed battery cell configurations may provide excellent distribution of movement of the electrodes within the battery cell case, thereby preventing one of the electrodes from having excess movement. The jelly roll electrodes may be separated by foam layers, pads, or wraps, with each of the foam pieces accepting electrode expansion to more evenly distribute electrode movement and thereby reduce a maximum moving distance of the electrodes to prevent the possible damage of the joint between cell tabs and bus bar. Further, distributing the electrode movement may also reduce the risk of causing an overpressure condition in jelly roll electrodes that are located in the middle of a multiple wound jelly roll stack.

The new design can be applied on prismatic cells with various chemistries, including traditional lithium-ion cell with liquid electrolyte and solid-state battery cell, or cells with high-expansion anodes, such as high silicon content anode and lithium metal.

A variety of materials may be utilized for the foam layers or wraps. Various types of materials have excellent chemical resistance to electrolytes, such as silicone rubbers, polyurethanes, or composites. Such materials may be used as foam with desired compression force, thickness, density, and thermal propagation delay function, etc. In some embodiments, the porous foam may absorb little or no liquid electrolyte through use of a nonporous surface coating layer or by creating a different surface polarity of the foam with that of the liquid electrolyte.

An effect of the usage of foams within the battery cell upon cell energy density and specific energy may be reduced or negligible due to a wide strain range and low density of the selected foam material.

The foam layers or wraps may employ various geometries and do not require full or total coverage of the electrode. As a result, tab connections may be disposed at various locations upon the battery cell open ends of or through-holes in the foam.

The disclosed foam layers and wraps may be utilized in prismatic can cells that are rectangular in shape. The disclosed foam layers and wraps may be applied to cylindrical battery cells with wound jelly roll electrodes or stacked electrodes.

The internal or built-in foam absorb the large expansion of the electrode stack during cell charging while maintaining the desired electrode pressure range. The disclosed built-in foam may be used on prismatic battery cells with lithium-ion cell chemistries with either a liquid electrolyte or solid-state cell chemistries. The disclosed built-in foam also can be used with a wound jelly roll electrode stack, stacked flat electrodes, or with other electrode geometries. The built-in foams may absorb the electrode expansion uniformly.

The disclosed prismatic battery cell may be described as a standalone prismatic battery cell, as opposed to prismatic battery cells that may include foam mechanisms or features located externally to the prismatic battery cell.

A prismatic battery cell may include a single electrode stack and a set of built-

in foam enabling the single electrode stack to move within the hard outer case of the prismatic battery cell as the electrode stack expands and shrinks. In another embodiment, a plurality of electrode stacks with a set of built-in foam between each of the electrode stacks may reduce an overall relative movement of the electrode stacks relative to the hard outer case, thereby reducing wear upon the electrodes and providing excellent battery cell lifespan.

The disclosed foam structures within the battery cell may reduce or eliminate battery cell case deformation. The disclosed battery cell configuration including the foam structures may reduce or eliminate battery module deformation. The disclosed foam structures may provide for control over internal pressures within the battery cell, maintaining at least a minimum desired internal pressure to encourage contact between the battery cell components and avoiding overpressure conditions. The foam may be configured to provide for uniform internal pressure or excellent pressure distribution within the battery cell. The disclosed foam may reduce or eliminate jelly roll electrode deformation and electrode stack deformation.

In one embodiment, silicone rubber foams may be utilized within the disclosed battery cell configurations. One exemplary material includes BISCO® BF-1000which is commercially available through the Rogers Corporation of Chandler, Arizona, United States. BF-1000 exhibits around 79% compression when the pressure reached to the manufacturer suggested maximum stress of 600 kilopascals of the foam materials. Such excellent compression provides significant space to neighboring expanding cell electrodes. Another exemplary material includes Rogers ProCell™ Series PCL-350 which is commercially available through the Rogers Corporation of Chandler, Arizona, United States. Another exemplary material includes polyurethane foam PORON®-43RL which is commercially available through the Rogers Corporation of Chandler, Arizona, United States. Another exemplary material includes polyurethane foam PORON® 4701 which is commercially available through the Rogers Corporation of Chandler, Arizona, United States. Another exemplary material includes a multifunctional composite film, including but not limited to the Rogers ProCell™M Series PCL-350 that contains multilayer films of PORON®/mica/aerogel/fabric, for enhanced thermal performance such as thermal propagation prevention or delay in addition to pressure management. These materials are provided as non-limiting examples of materials that may be utilized for the foam structures described herein.

In one exemplary battery cell configuration, a 20 micrometer lithium metal anode may be utilized with silicone rubber foams in various thickness. In exemplary usage of lithium metal anodes in three alternative configurations, cach configuration significantly increases the cell energy density. Maximum internal cell pressure as the cells are put through a lithiation/charging cycle varies based upon a thickness of the foam. Increasing the thickness of the foams decreases the cell pressure. In one exemplary threshold, one may select an optimal foam thickness by increasing a thickness of the foam utilized until the maximum internal pressure falls below a threshold level, such as an exemplary threshold of 600 kilopascals. In one embodiment, such a threshold may be met with a 10 millimeter thick foam layer. In one embodiment, a foam deflection limit 600 kilopascals resulting in about 0%-80% strain in the foam may be defined. In another embodiment, a foam deflection limit of 600 kilopascals resulting in about 65%-80% strain in the foam may be defined.

In one embodiment, foam with low absorbency, surface coatings with low porosity, or reverse polarity to the electrolyte may be utilized to reduce electrolyte absorption in the foam. In one embodiment, volumetric electrolyte absorption by the foam may be in a range from 0% of the volume of the foam to 4% volume of the foam. In one embodiment, the foam may be described as absorbing less than 6% of total cell electrolyte by volume.

Exemplary foam materials may provide pressure mitigation and may additionally provide thermal propagation prevention or delay.

Wound jelly roll electrodes and stacked electrodes may be wrapped with foam prior to being inserted in the prismatic can. This works for various relative positions of cell tabs and various electrode stacking directions. The disclosed foam structures may provide improved thermal performance by filling up gaps in the cells.

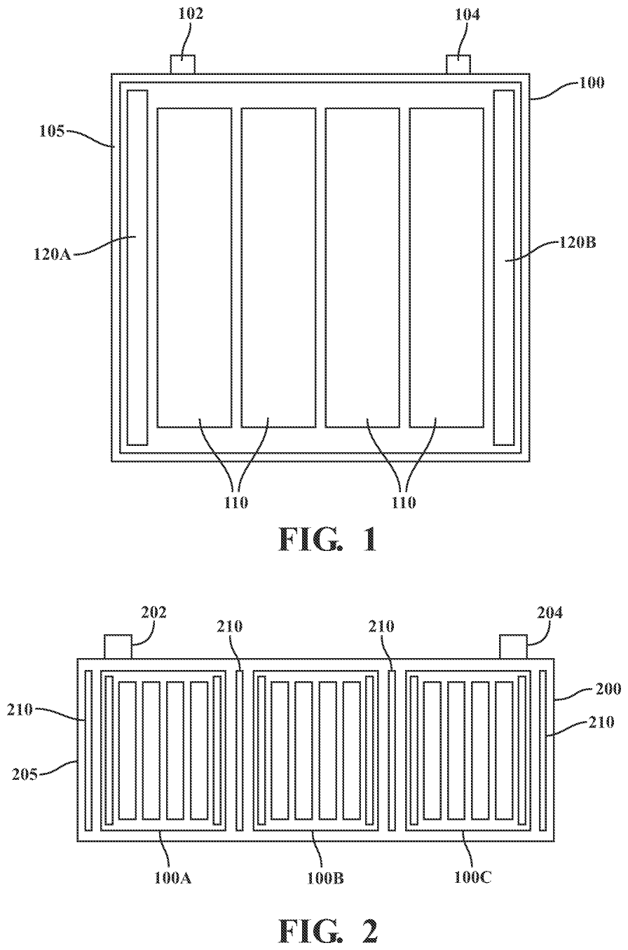

FIG. 1 schematically illustrates in side cross-sectional view an exemplary prismatic battery cell 100 including a hard outer case 105, electrode stacks 110, and at least one built-in foam structure, embodied by foam layers 120A, 120B in FIG. 1. pressing upon the electrode stacks 110. Throughout the illustrated Figures, layers, electrodes, etc. may be illustrated with space between the layers for purposes of clearly distinguishing the various components from each other. In operation, the various components are in contact with each other and providing pressure upon each other. As the electrode stacks 110 expand as the anodes thereof expand, the foam layer 120A, 120B are compressed up to a maximum pressure when the anodes are fully expanded. The battery cell 100 includes a first tab 102 and a second tab 104, which are illustrated on a top surface of the battery cell 100. In other embodiments, the first tab 102 and the second tab 104 may be on different surfaces or opposite surfaces of the battery cell 100. An inner surface of the hard outer case 105 defines an inner volume of the hard outer case 105.

FIG. 2 schematically illustrates in cross-sectional view a battery module 200 including a plurality of battery cells 100A, 100B, 100C. The battery cells 100A, 100B, 100C are each equivalent to the battery cell 100 of FIG. 1, illustrating that the battery cell 100 may be utilized as multiple cells within a single battery module 200. Adhesive tape/thermal insulation 210 is illustrated disposed between the battery cells 100A, 100B, 100C, between the battery cell 100A and a hard outer case 205 of the battery module 200, and between the battery cell 100C and the hard outer case 205. A first module tab 202 and a second module tab 204 are additionally illustrated. Foam structures within each of the battery cells 100A. 100B, 100C provide desirable pressure upon electrode stacks therewithin and, upon expansion of the electrode stacks, compress to absorb the expansion without putting excessive pressure/strain upon the outer cases of the battery cells 100A, 100B, 100C. By reducing the pressure/strain upon the outer cases of the battery cells 100A, 100B, 100C, a resulting pressure/strain upon the hard outer case 205 is similarly reduced.

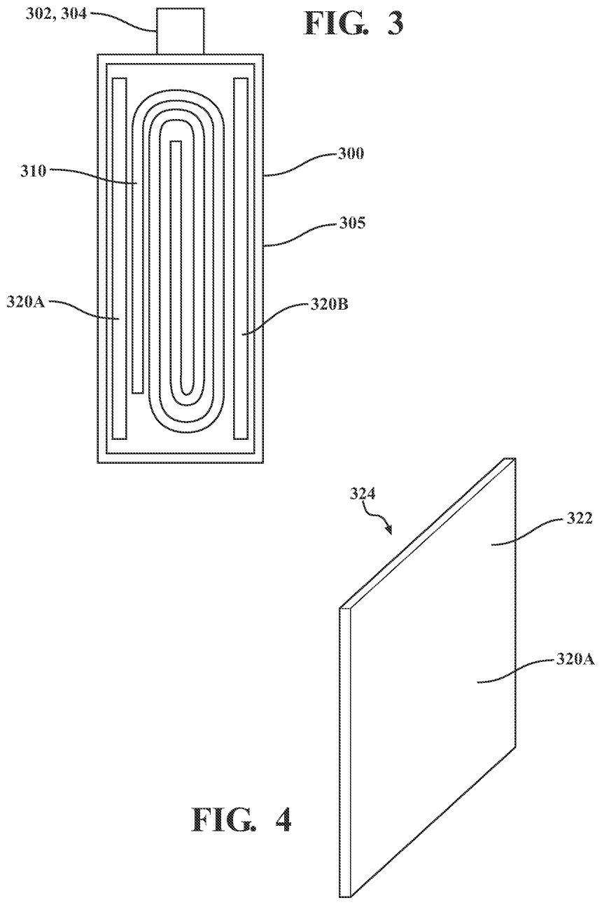

FIG. 3 schematically illustrates in cross-sectional view a battery cell 300 including a jelly roll electrode 310 and foam layers 320A, 320B. The jelly roll electrode 310 may include a plurality of flexible layers including an anode layer, a cathode layer, and a separator layer there between. A first tab 302 and a second tab 304 are illustrated. The foam layer 320A is disposed between a first side of the jelly roll electrode 310 and a hard outer case 305 of the battery cell 300. The foam layer 320B is disposed between a second side of the jelly roll electrode 310 and the hard outer case 305. The foam layers 320A. 320B are configured for applying desirable pressure upon the jelly roll electrode 310 and for compressing when the jelly roll electrode 310 expands. An inner surface of the hard outer case 305 defines an inner volume of the hard outer case 305.

FIG. 4 schematically illustrates in perspective view the foam layer 320A of FIG. 3. The foam layer 320B of FIG. 3 is a substantial mirror image to the foam layer 320A. The foam layer 320A is illustrated including a first planar side 322 configured for abutting the jelly roll electrode 310 of FIG. 3. The foam layer 320A is further illustrated including a second planar side 324 configured for abutting an inner surface of the hard outer case 305 of FIG. 3. A thickness of the foam layer 320A may be defined as a distance between the first planar side 322 and the second planar side 324.

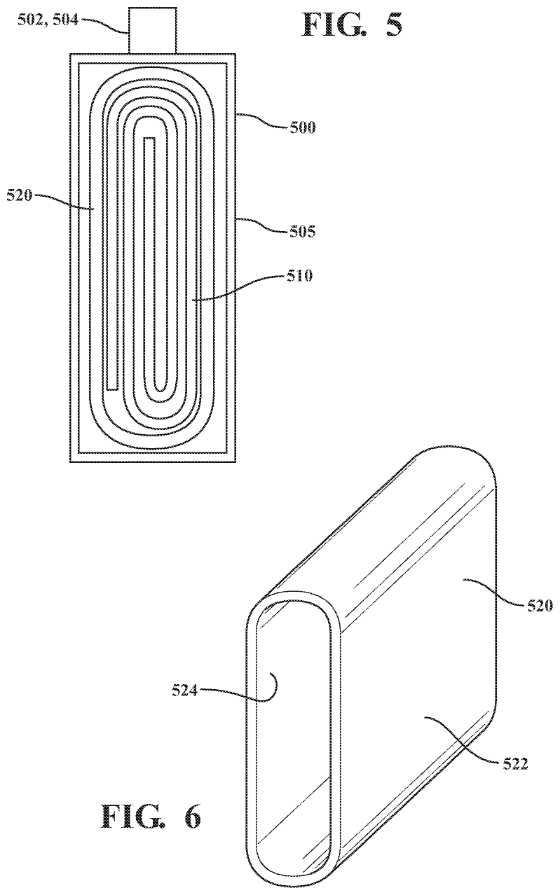

FIG. 5 schematically illustrates in cross-sectional view a battery cell 500 including a jelly roll electrode 510 and a foam wrap 520. A first tab 502 and a second tab 504 are illustrated. The foam wrap 520 is illustrated disposed around the jelly roll electrode 510 and between the jelly roll electrode 510 and the hard outer case 505. The foam wrap 520 is configured for applying desirable pressure upon the jelly roll electrode 510 and for compressing when the jelly roll electrode 510 expands. An inner surface of the hard outer case 505 defines an inner volume of the hard outer case 505.

FIG. 6 schematically illustrates in perspective view the foam wrap 520 of FIG. 5. The foam wrap 520 is illustrated including an outer surface 522 and an inner surface 524. The outer surface 522 is configured for abutting an inner surface of the hard outer case 505 of FIG. 5. The inner surface 524 is configured for abutting an outer surface of the jelly roll electrode 510. A thickness of the foam wrap 520 may be defined as a distance between the outer surface 522 and the inner surface 524.

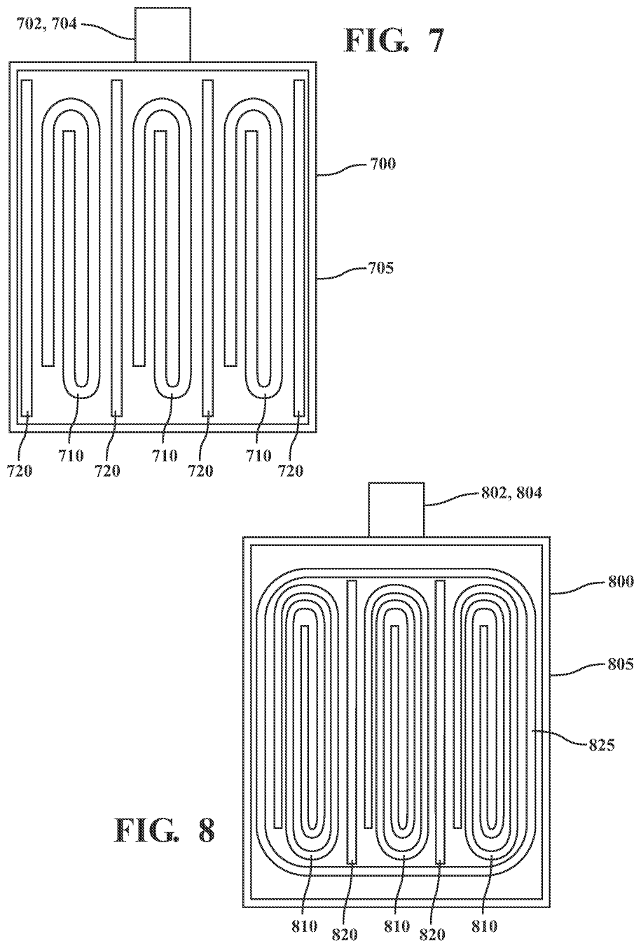

FIG. 7 schematically illustrates in cross-sectional view a battery cell 700 including a plurality of jelly roll electrodes 710 disposed between a plurality of foam layers 720. A first tab 702 and a second tab 704 are illustrated upon the battery cell 700. A first portion of the foam layers 720 are illustrated disposed between separating the jelly roll electrodes 710. A remaining portion of the foam layers 720 are illustrated disposed between jelly roll electrodes 710 and a hard outer case 705 of the battery cell 700. The foam layers 720 are each configured to apply a desirable pressure upon the jelly roll electrodes 710 and for compressing when the jelly roll electrodes 710 expand. By disposing compressing foam structures on both of the flat sides of each of the jelly roll electrodes 710, each of the jelly roll electrodes 710 may essentially expand in place or with little translating movement within the hard outer case 705. An inner surface of the hard outer case 705 defines an inner volume of the hard outer case 705.

FIG. 8 schematically illustrates in cross-sectional view a battery cell 800 including a plurality of jelly roll electrodes 810, a plurality of foam layers 820 disposed between the jelly roll electrodes 810, and a foam wrap 825 disposed surrounding the jelly roll electrodes 810 and between the jelly roll electrodes 810 and a hard outer case 805 of the battery cell 800. A first tab 802 and a second tab 804 are illustrated upon the battery cell 800. The foam layers 820 and the foam wrap 825 are cach configured to apply a desirable pressure upon the jelly roll electrodes 810 and for compressing when the jelly roll electrodes 810 expand. By disposing compressing foam structures on both of flat sides of each of the jelly roll electrodes 810, each of the jelly roll electrodes 810 may essentially expand in place or with mitigated electrode deformation or damage. An inner surface of the hard outer case 805 defines an inner volume of the hard outer case 805.

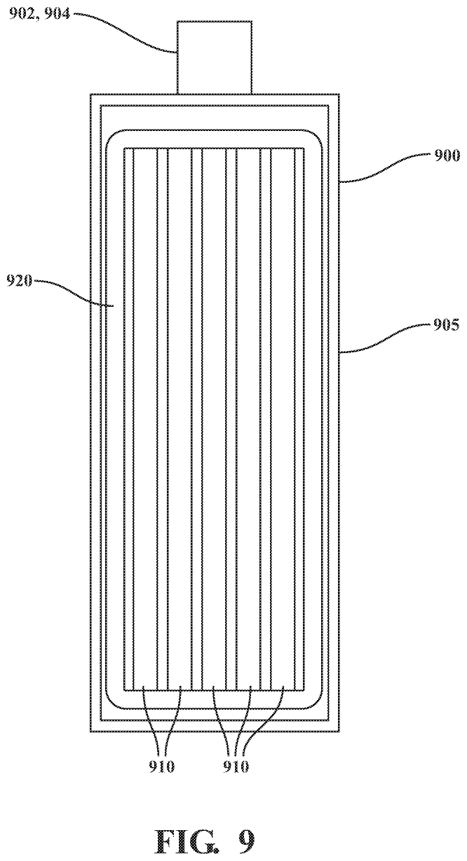

FIG. 9 schematically illustrates in cross-sectional view a battery cell 900 including a plurality of electrode stacks 910 and a foam wrap 920 disposed surrounding the electrode stacks 910. A first tab 902 and a second tab 904 are illustrated upon the battery cell 900. The foam wrap 920 is configured to apply a desirable pressure upon the electrode stacks 910 and for compressing when the electrode stacks 910 expand. By disposing compressing foam structures on both of flat sides of each of the electrode stacks 910, each of the electrode stacks 910 may essentially expand in place or with little translating movement within the hard outer case 905. An inner surface of the hard outer case 905 defines an inner volume of the hard outer case 905.

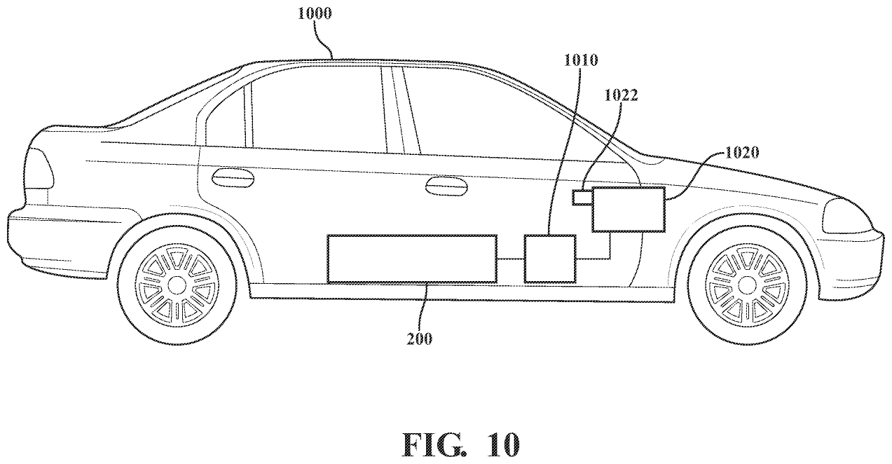

FIG. 10 schematically illustrates an exemplary device 1000 including the battery module 200 and utilizing electrical energy stored there within. The exemplary device 1000 includes a vehicle. Other embodiments of the device 1000 may include a boat, an airplane, construction equipment, or a power generation system. The device 1000 is further illustrated including a motor generator unit 1020 including an output shaft 1022 configured for providing a useful output torque which may be utilized, for example, to provide motive force to a vehicle. A power inverter 1010 may be useful, for example, for transforming electrical energy from a direct current useful to the battery module 200 and an alternating current, for example, a three-phase alternating current, useful to the motor generator unit 1020. Device 1000 and the battery module 200 therein are exemplary and intended to be non-limiting.

The disclosed foam layers or foam wraps may be used in a combination with the built-in springs within the battery cell for the similar function of reducing the battery cell internal pressure and mitigating the cell case deformation for the battery cell with high-expansion anodes. FIG. 11 schematically illustrates in cross-sectional view an exemplary battery cell 1100 including a plurality of electrode stacks 1110, a first foam layer 1120A, a second foam layer 1120B, and a spring 1130 configured to apply compressive force upon the electrode stacks 1110 and the foam layers 1120A, 1120B. The electrode stacks 1110 may be substituted with one or more jelly roll electrodes. A tab 1102 and a hard outer case 1105 are illustrated. The spring 1130 is connected to the hard outer case 1105 at a first end and to a spring supporter plate 1132 on the other side. Through the spring supporter plate 1132, the spring 1130 transmits compressive force upon a first side of the foam layer 1120A. The foam layers 1120A and 1120B are configured to apply a desirable pressure upon the electrode stacks 1110 and for compressing when the electrode stacks 1110 expand. The spring 1130 may additionally compress when the electrode stacks 1110 expand. The force applied by the spring 1130 and the force created by compressing the foam layers 1120A and 1120B create compression upon the electrode stacks 1110. An inner surface of the hard outer case 1105 defines an inner volume of the hard outer case 1105.

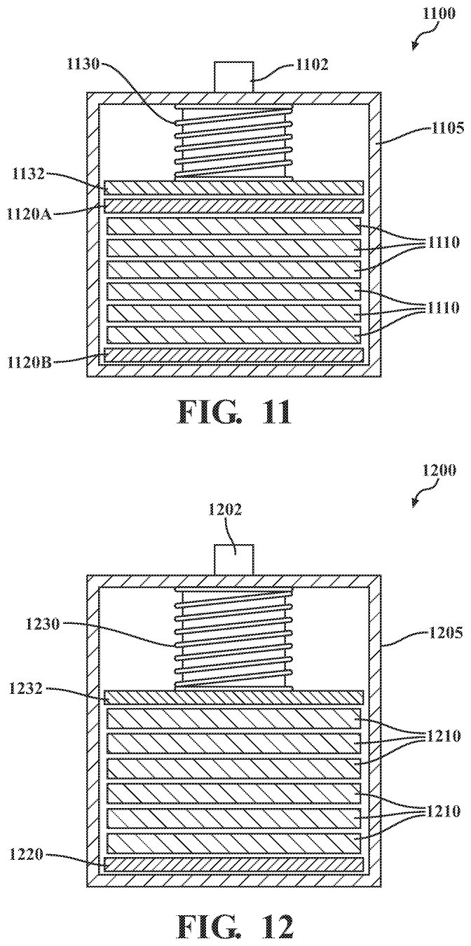

FIG. 12 schematically illustrates in cross-sectional view an exemplary battery cell 1200 including a plurality of electrode stacks 1210, a foam layer 1220, and a spring 1230 configured to apply compressive force upon the electrode stacks 1210 and the foam layer 1220. The electrode stacks 1210 may be substituted with one or more jelly roll electrodes. A tab 1202 and a hard outer case 1205 are illustrated. The spring 1230 is connected to the hard outer case 1205 at a first end and to a spring supporter plate 1232 on the other side. Through the spring supporter plate 1232, the spring 1230 transmits compressive force upon a first side of one of the electrode stacks 1210. The foam layer 1220 is configured to apply a desirable pressure upon the electrode stacks 1210 and for compressing when the electrode stacks 1210 expand. The spring 1230 may additionally compress when the electrode stacks 1210 expand. The force applied by the spring 1230 and the force created by compressing the foam layer 1220 create compression upon the electrode stacks 1210. An inner surface of the hard outer case 1205 defines an inner volume of the hard outer case 1205.

While the best modes for carrying out the disclosure have been described in detail, those familiar with the art to which this disclosure relates will recognize various alternative designs and embodiments for practicing the disclosure within the scope of the appended claims.

What is claimed is:

1. A prismatic battery cell, comprising:
a hard outer case including an internal volume;
an electrode stack or a jelly roll electrode disposed within the internal volume; and
a foam structure disposed within the internal volume configured for applying a desirable pressure upon the electrode stack or the jelly roll electrode and for compressing when the electrode stack or the jelly roll electrode expands.

2. The prismatic battery cell of claim 1, wherein the electrode stack or the jelly roll electrode includes a silicon anode or a lithium metal anode.

3. The prismatic battery cell of claim 1, wherein, when the electrode stack of the jelly roll electrode expands, the foam structure is configured for exhibiting strain in a range from 0% to 80% at a pressure of less than 600 kilopascals.

4. The prismatic battery cell of claim 1, further comprising a liquid electrolyte; and
wherein the foam structure is configured for absorbing the liquid electrolyte in a range from 0% of a volume of the foam structure to 4% of the volume of the foam structure.

5. The prismatic battery cell of claim 1, wherein the foam structure includes:
a first foam layer abutting a first side of the electrode stack or the jelly roll electrode and disposed between the first side of the electrode stack or the jelly roll electrode and an inner surface of the hard outer case; and
a second foam layer abutting a second side of the electrode stack or the jelly roll electrode and disposed between the second side of the electrode stack or the jelly roll electrode and the inner surface of the hard outer case.

6. The prismatic battery cell of claim 1, wherein the prismatic battery cell comprises the jelly roll electrode;
wherein the battery cell includes a plurality of jelly roll electrodes; and
wherein the foam structure includes a foam layer disposed between a first of the plurality of jelly roll electrodes and a second of the plurality of jelly roll electrodes.

7. The prismatic battery cell of claim 6, wherein the foam layer is a first foam layer;
wherein the prismatic battery cell further comprises:
a second foam layer abutting a first side of a first of the plurality of jelly roll electrodes and disposed between the first side and an inner surface of the hard outer case; and
a third foam layer abutting a second side of a second of the plurality of jelly roll electrodes and disposed between the second side and the inner surface of the hard outer case.

8. The prismatic battery cell of claim 6, further comprising a foam wrap surrounding the plurality of jelly roll electrodes.

9. The prismatic battery cell of claim 1, wherein the prismatic battery cell comprises the electrode stack; and
wherein the foam structure includes:
a first foam layer abutting a first side of the electrode stack and disposed between the first side of the electrode stack and an inner surface of the hard outer case; and
a second foam layer abutting a second side of the electrode stack and disposed between the second side of the electrode stack and the inner surface of the hard outer case.

10. The prismatic battery cell of claim 1, wherein the prismatic battery cell comprises the electrode stack; and
wherein the foam structure is a foam wrap surrounding the electrode stack.

11. The prismatic battery cell of claim 1, wherein the foam structure is constructed with a silicone rubber.

12. The prismatic battery cell of claim 1, wherein the foam structure is constructed with a polyurethane material.

13. The prismatic battery cell of claim 1, wherein the foam structure is constructed of a composite material or multilayer material including a silicone rubber or a polyurethane material.

14. The prismatic battery cell of claim 1, further comprising a first tab and a second tab; and
wherein the foam structure includes open ends enabling various positions for the first tab upon the prismatic battery cell and for the second tab upon the prismatic battery cell.

15. The prismatic battery cell of claim 1, further comprising a liquid electrolyte; and
wherein the foam structure includes a different surface polarity from a polarity of the liquid electrolyte.

16. The prismatic battery cell of claim 1, further comprising a built-in spring applying a compressive force upon a first side of the electrode stack or jelly roll electrode; and
wherein the foam structure includes a foam layer in contact with a second side of the electrode stack or jelly roll electrode.

17. The prismatic battery cell of claim 1, further comprising a built-in spring applying a compressive force upon a first side of the electrode stack or jelly roll electrode;
wherein the foam structure includes a first foam layer in contact with a second side of the electrode stack or jelly roll electrode; and
further comprising a second foam layer disposed between the built-in spring and the first side of the electrode stack or jelly roll electrode.

18. A battery module, comprising:
a plurality of battery cells, wherein each of the plurality of battery cells includes:
a hard outer case including an internal volume;
an electrode stack or a jelly roll electrode disposed within the internal volume; and
a foam structure disposed within the internal volume configured for applying a desirable pressure upon the electrode stack or the jelly roll electrode and for compressing when the electrode stack or the jelly roll electrode expands.

19. A system including a device including a battery module, the system comprising:
the device, including:
the battery module including a plurality of battery cells, wherein each of the plurality of battery cells includes:
a hard outer case including an internal volume;
an electrode stack or a jelly roll electrode disposed within the internal volume; and
a foam structure disposed within the internal volume configured for applying a desirable pressure upon the electrode stack or the jelly roll electrode and for compressing when the electrode stack or the jelly roll electrode expands.

20. The system of claim 19, wherein the device is a vehicle.
